(19) United States
(12) Patent Application Publication
(10) Pub. No.: US 2008/0250394 A1
(43) Pub. Date: Oct. 9, 2008

(54) Synchronizing external documentation with code development

(75) Inventors: Brian M. Jones, Redmond, WA (US); Tristan A. Davis, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/784,163

(22) Filed: Apr. 4, 2007

(51) Int. Cl. G06F 9/44

(52) U.S. Cl. 717/123

(57) ABSTRACT

Documentation is automatically updated in response to the source code being modified without requiring human intervention. Elements within the source code are marked such that when changes are made to the marked elements within the source code, the documentation is updated to reflect the changes. Therefore, the code may continue to be modified while simultaneously allowing the documentation to be developed. The documentation is stored externally from the source code such that rich formatting may be applied to the documentation and that the documentation process does not inadvertently corrupt the source code.

### RELATED APPLICATIONS

U.S. patent applications Ser. No. ______, entitled “GENERATING A WORD-PROCESSING DOCUMENT FROM DATABASE CONTENT” and Ser. No. ______, entitled “REPOPULATING A DATABASE WITH DOCUMENT CONTENT” assigned to the assignee of the present application and filed on even date herewith, are related to the present application.

### BACKGROUND

During a software development process it is common to frequently revise the code in order to properly develop the desired product. The software development process may include changes made to the code as a result of both internal and external feedback received during the development process. This feedback often results in the code substantially changing over time. These code changes during the development process make it difficult to complete the documentation that accompanies the code since the documentation relates closely to the code. The documentation for the code, therefore, is generally not completed until long after the code has been stable for a period of time.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Documentation is automatically updated in response to the source code being modified. When changes are made to the source code, the documentation is synchronized such that changes made to the code are reflected in the documentation. Therefore, the code may continue to be modified while simultaneously allowing the documentation to be developed. The documentation may be stored externally from the source code such that rich formatting may be applied to the documentation and that the documentation process does not inadvertently corrupt the source code.

### BRIEF DESCRIPTION OF THE DRAWINGS

FIG. 1 illustrates an exemplary computing device;

FIG. 2 shows a synchronization system for synchronizing documentation with code development; and

FIG. 3 shows an illustrative process for synchronizing documentation with code development.

### DETAILED DESCRIPTION

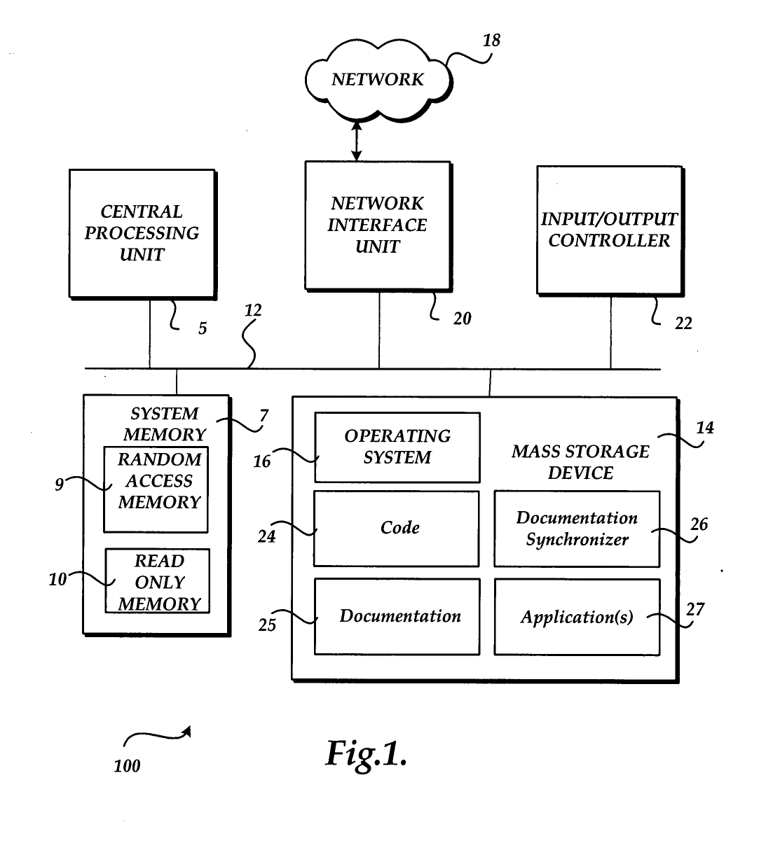

Referring now to the drawings, in which like numerals represent like elements, various embodiment will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured as a desktop or mobile computer and includes a central processing unit 5 (“CPU”), a system memory 7, including a random access memory 9 (“RAM”) and a read-only memory (“ROM”) 10, and a system bus 12 that couples the memory to the CPU 5. A basic input/output system containing the basic routines that help to transfer information between elements within the computer, such as during startup, is stored in the ROM 10. The computer 100 further includes a mass storage device 14 for storing an operating system 16, application programs 24, and other program modules, which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100

According to various embodiments, computer 100 may operate in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide output to a display screen 28, a printer, or other type of output device.

As mentioned briefly above, a number of program modules and data files may be stored in the mass storage device 14 and RAM 9 of the computer 100, including an operating system 16 suitable for controlling the operation of a networked personal computer, such as the WINDOWS VISTA operating system from MICROSOFT CORPORATION of Redmond, Wash. The mass storage device 14 and RAM 9 may also store one or more program modules. In particular, the mass storage device 14 and the RAM 9 may store code 24. Code 24 may be any code that exists on a system. For example, the code may be in the form of a markup language (i.e. HTML, XML, XSD) and/or in the form of a programming language (i.e. C, C++). Generally, code 24 is any type of code that can be documented. Documentation 25 documents code 24. For instance, documentation 25 may define the function, strings, variables, and the like relating to code 24. While documentation 25 is shown on computer 100, documentation 25 may be stored within in any data store, such as on a data store on network 18.

The documentation synchronizer 26 is operative to automatically synchronize documentation 25 with code 24. For example, when changes are made to code 24, documentation synchronizer 26 accesses code 24 and automatically updates documentation 25 to reflect the changes. For example, a function name may change, a parameter may change, a relationship may change, and the like. Documentation 25 for code 24 is automatically updated without requiring a human to rewrite the underlying content. The content that is updated may also be flagged such that a user can change and/or edit the documentation. Additionally, since the documentation 25 may be stored externally from the code 24 rich formatting may be applied to the documentation. Although documentation synchronizer 26 is shown as a separate application, it may be included directly within an application program 27 or at some other location. The operation of documentation synchronizer 26 will be described in more detail below.

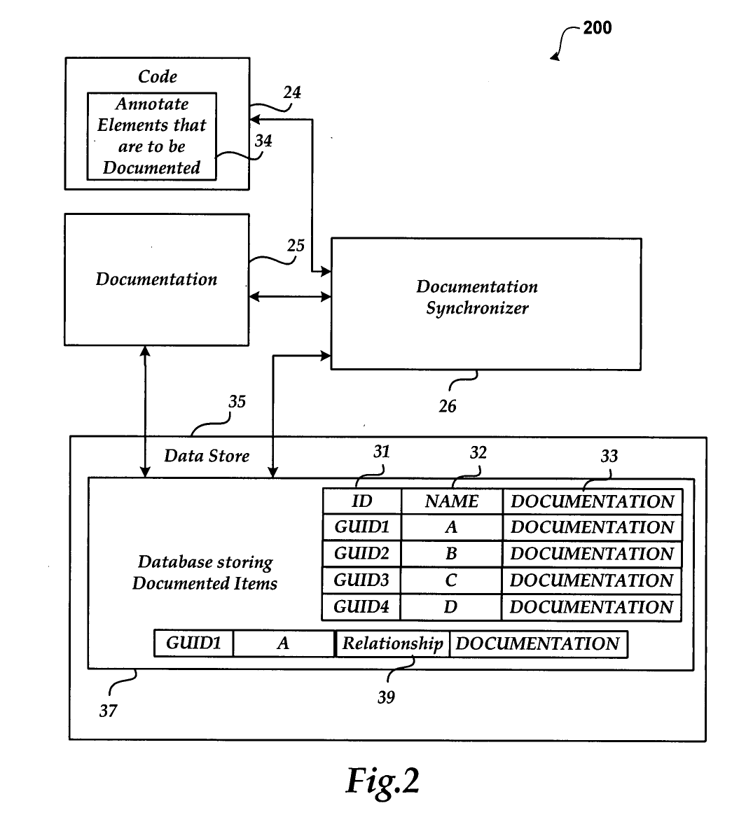

FIG. 2 shows external documentation synchronization system 200 for automatically synchronizing documentation with code development. As illustrated, synchronization system 200 includes documentation synchronizer 26, code 24, documentation 25 and data store 35. System 200 is directed at allowing modifications to be made to source code, such as XML Schemas, as needed to get the desired final format, while still allowing documentation to be developed while the code is still being changed. This allows the documentation to be started even when the code is incomplete and/or under development.

As discussed above, the code 24 may be any source code. For illustrative purposes, and not intended to be limiting, an example of synchronizing documentation 25 with an XML based syntax will be described. When developing source code 24, such as an XML-based syntax, it is common to frequently revise the contents of that language during the development period. These revisions are used to properly develop the optimal desired final language, work out issues with the interim product, and provide ‘beta’ versions of the proposed output in order to get both internal and external feedback to be used by the development team in its product development. These changes often result in an XML Schema definition whose contents substantially change over time. For example, the names of elements and attributes are commonly modified, the content models of elements changes, the hierarchy (parent/child relationships) are consistently added and deleted, and so on.

Documentation 25 provides documentation for code 24. Generally, documentation 25 is created to be user-friendly and that completely and accurately describes code 24. In the example of revising an XML based syntax, documentation 25 is synchronized by documentation synchronizer 26 in response to the revisions to the XML syntax (code 24). Documentation synchronizer 26 is configured to generate documentation directly from the content of the XML Schema files such that an update to one of the XML schema files is used to automatically update the corresponding documentation 25. According to one embodiment, documentation 25 is stored externally from code 24. Storing documentation 25 externally from code 24 keeps the documenters from inadvertently making changes to the source code 24 and also allows the documentation 25 to utilize richer formatting than might be afforded if that documentation was stored inline the in the XML schema files (code 24).

Elements within the code 24 that are to be documented are identified within the source code such that documentation synchronizer 26 can identify the elements that are to be documented. The annotation of the elements 34 to be documented identifies the source code element even when an identifying characteristic, such as the name, of the element changes. For example, in XML elements, even when the typical identifying characteristics of those elements change (e.g., their names, content models, etc.) the element remains associated with the documentation. In order to associate the elements to be documented, each element within the source code that is documented is annotated with a unique ID. For example, each item within a schema that is to be documented is annotated with a separate unique GUID (globally unique identifier) in a that namespace unique from that used to define the document structure. The annotation of the item allows the association of external information with that item within the XML hierarchy.

According to one embodiment, each unique identifier which corresponds to an element is reflected in the creation of a row in a database 37 stored in a separate location, such as data store 35, from the storage of the actual code (in this example XML schemas). The database 37 is populated with the current information about each of these XML elements and attributes that are to be documented, such that they can be queried for the current information without impacting access to the original XML schema data location. For example, each row may include an ID 31, a name 32 and the corresponding documentation for the element. Many more fields may be contained in each row. For instance, a field may contain metadata relating to the element. Another field that may be included within database 37 is a relationship field 39 that specifies the relationship of the element to another element. For example, the relationship filed may be used to store the parent/child relationships of the XML schema files. This also allows the parent/child relationships to be determined from outside of the XML Schema code 24. Database 37 may be configured such that it provides an easy way to view the functionality of the code without directly accessing the code.

Whenever the XML schemas 24 are modified, the developers performing that modification need not have any thought to the impact to the documentation 25. The developers, however, may add new GUIDs to the new elements added to the database 37 which they desire to be documented. For example, a developer may add a new element which now needs to be documented. The documenters may therefore freely update the documentation 25 without worry to the impacts on the documentation process. According to one embodiment, the documentation for each element is extracted from database 37 and placed into documentation 25. Documentation 25 may take many different forms such as a single file, multiple files and the like. For example, documentation 25 from database 33 could be extracted and then placed into templates into documentation 25. Documentation could be in the form of MICROSOFT WORD files or some other document format. Similarly, changes made to documentation 25 could be used to populate the documentation field 33 in database 37.

When the schemas are changed in the source code location 24, documentation synchronizer 26 automatically runs through each of the annotated items within the code 24 and updates the corresponding entries in the database 37 for the documentation as needed (modifying details of names, content models, etc.). This can be done with little cost/effort as the GUIDs associated with each element provide a permanent link from the appropriate source element to the corresponding destination row. When the source code 24 is changed, the developers can optionally use the standard XML schema documentation within the Schema files to provide “seed” information for more formal documentation, since the slot for such information is not being used to store the final product. Similarly, when the source code is in the form of a programming language the comments field for the function may be used to populate at least a portion of the documentation field 33. Additionally, some other field may be used to populate a database record. When the schemas are changed, the new parent/child relationships can easily be deduced from the resulting XSDs and stored in an independent location along with the documentation. Name changes can also be automatically reflected in the output via a simple search/replace technique. For example, if <foo/> becomes <bar/> then all instances of “foo” can be replaced with “bar” right within the documentation output, saving additional time. Essentially, the update of the XSDs and the documentation can proceed in two independent tracks, linked only by the GUIDs so as to avoid slowing down the development process.

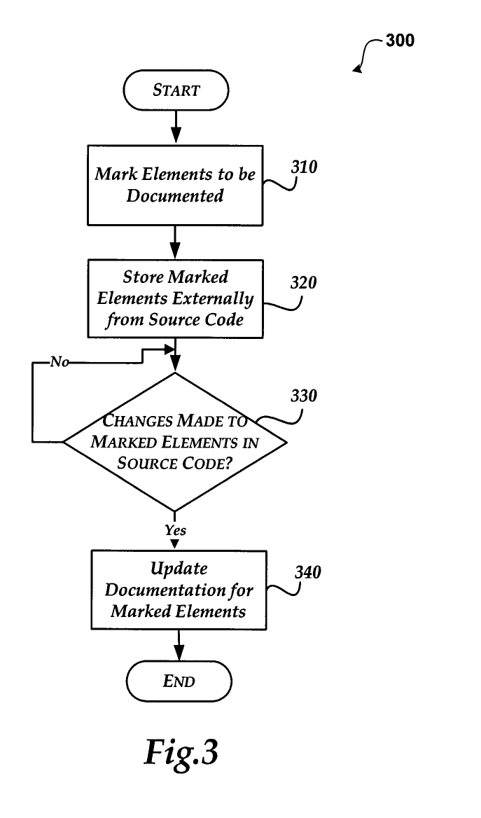

Referring now to FIG. 3, an illustrative process for synchronizing documentation with code development is described.

When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start operation, the process flows to operation 310, where the elements to be documented within the source code are marked. The elements of the source code are marked such that each element to be documented is uniquely identified. According to one embodiment, a GUID is associated with each element such that even if an identifying characteristic of the element changes it can still be linked to the documentation. Elements within the source code may be marked for documentation at any time. For instance, a group of elements may be initially marked and then another group of elements could be marked further along in the development process.

Moving to block 320, the marked elements are stored externally from the source code. When the documentation 25 is stored externally from the code 24, rich formatting may be applied to the documentation and the risk of corrupting the source code by a documenter is reduced. According to one embodiment, each element having a GUID within the source code is stored in a separate list that includes the GUID, the name of the element (which can change) and the corresponding documentation. The documentation may be stored within the list and/or the documentation field could a link or some other reference to the documentation. For example, the documentation field could indicate the file where to find the documentation for the element.

Moving to decision block 330, a determination is made as to whether changes have been made to any of the marked elements within the source code. This determination may be made periodically, upon an action by a user, when the source code is saved, and the like.

When no changes have been made to any of the elements the process returns to decision block 330 to wait for changes to an element.

When there are changes made to at least one of the marked elements in the source code, the process moves to block 340 where the documentation for the marked elements that have been changed is updated. An element could change in many different ways. For example, its name could change, an attribute could change, a parameter such as a return value could change, and the like.

The process then flows to an end operation and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for synchronizing documentation with code development, comprising:
marking elements within code to be documented;
storing a reference to each of the elements externally from the code;
automatically determining when a change to the code affects at least one of the marked elements;
automatically updating the reference to the element based upon the change; and
synchronizing the documentation corresponding to the change to the code.

2. The method of claim 1, wherein synchronizing the documentation with the change to the code comprises storing the documentation separately from the code and providing rich formatting to the documentation.

3. The method of claim 1, wherein marking the elements within code to be documented comprises associating a unique identifier with each of the elements.

4. The method of claim 1, wherein storing the reference to each of the elements externally from the code comprises storing at least one property of the element and a unique identifier of the element.

5. The method of claim 1, wherein storing the reference to each of the elements externally from the code comprises storing each of the elements within a database.

6. The method of claim 5, further comprising storing a relationship of the element within the database such that a parent/child relationship can be determined.

7. The method of claim 1, wherein automatically determining when the change to the code affects the at least one of the marked elements comprises accessing the code and searching for the change to at least one of the marked elements.

8. The method of claim 1, wherein the code is an XML based syntax.

9. A computer-readable medium having computer-executable instructions for synchronizing external documentation with code development, the instructions comprising:
marking elements within code that are to be documented;
automatically determining when a change to the code affects at least one of the marked elements such that the documentation needs to be updated; and
synchronizing the documentation corresponding to the change to the code.

10. The computer-readable medium of claim 9, further comprising storing a reference to each of the elements externally from the source code and automatically updating the reference to the element when the change has been made to the element.

11. The computer-readable medium of claim 10, wherein synchronizing the documentation with the change to the code comprises storing the documentation separately from the code.

12. The computer-readable medium of claim 10, wherein marking the elements within code to be documented comprises associating a global unique identifier with each of the elements within the code to be documented.

13. The computer-readable medium of claim 12, wherein storing the reference to each of the elements externally from the source code comprises storing at least one property of the element, a unique identifier of the element, and corresponding documentation for the element within a database.

14. The computer-readable medium of claim 13, further comprising storing a relationship of the element within the database such that a parent/child relationship can be determined between the elements within the database.

15. The computer-readable medium of claim 13, further comprising extracting the corresponding documentation for the element within the database and placing the documentation within a file having rich formatting.

16. The computer-readable medium of claim 13, wherein automatically determining when the change to the code affects the at least one of the marked elements comprises accessing the code and searching for the change to at least one of the marked elements.

17. The computer-readable medium of claim 13, wherein the code is an markup language based syntax.

18. A system for synchronizing external documentation with code development of a markup language based syntax, comprising:
a processor and a computer-readable medium;
an operating environment stored on the computer-readable medium and executing on the processor;
a data store that is configured to store the documentation separately from the code; wherein the code includes elements that are marked to be documented;
a database having rows and columns; wherein the database includes a reference to each of the marked elements including a unique identifier of the marked element, a name of the marked element, and documentation relating to the marked element; and
a documentation synchronizer that is configured to:
automatically determine when a change to the code affects at least one of the marked elements;
automatically update the reference to the element within the database based upon the change; and
synchronize the documentation corresponding to the change to the code.

19. The system of claim 18, wherein the database is further configured to store relationships of the marked elements such that a parent/child relationship of the marked elements can be determined.

20. The system of claim 19, wherein automatically determining when the change to the code affects the at least one of the marked elements comprises accessing the code and searching for the change to at least one of the marked elements.
